(19) United States
(12) Patent Application Publication
(10) Pub. No.: US 2020/0364669 A1
(43) Pub. Date: Nov. 19, 2020

(54) AGGREGATING CONSENT ACROSS RECORDS FOR RESPONDING TO CONSENT REQUESTS

(71) Applicant: salesforce.com, inc., San Francisco, CA (US)

(72) Inventors: Marla Hay, Portland, OR (US); Yu Chen, Bellevue, WA (US); Yvonne Zhou, San Francisco, CA (US); Michael Allan Friedman, Bellevue, WA (US); Shivan Kaul Sahib, Vancouver (CA)

(73) Assignee: salesforce.com, inc.

(21) Appl. No.: 16/411,765

(22) Filed: May 14, 2019

(51) Int. Cl. G06Q 10/10

(52) U.S. Cl. CPC G06Q 10/103

(57) ABSTRACT

A method for responding to a consent request for an action based on a set of records is described. The method includes receiving the consent request, including a set of identifiers and the action for obtaining consent; locating a first record of a first object type and a second record of a second data type, wherein the first record corresponds to a first identifier in the set of identifiers, the second record corresponds to a second identifier of the set of identifiers, and one or more of the first and second records includes consent information for performing the action; determining a final response based on the first and second records, wherein the final response includes at least one proceed element that indicates whether consent exists for the action based on at least the first and second records; and returning the final response as a response.

### TECHNICAL FIELD

One or more implementations relate to the field of consent management; and more specifically, to aggregating consent across records for responding to consent requests.

### BACKGROUND ART

Companies store data for a variety of parties using an assortment of different storage systems. Although these companies have access and physical control to data of parties, this control is limited by laws and regulations in applicable jurisdictions. Namely, privacy laws and regulations provide parties the legal right to control both management of their data and communications associated with the party (e.g., communications directed at the party). For example, the General Data Protection Regulation (GDPR) is a regulation in European Union (EU) law that covers data protection and privacy for all individuals/parties within the EU and the European Economic Area (EEA). An element of the GDPR and other similar regulations is obtaining consent from parties in relation to processing data and communications with parties. Companies have captured consent using a number of different data objects in a variety of different data models. Based on the variability of consent data in different data objects and corresponding data models, adjudicating consent to perform an action related to a party can be difficult.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram illustrating a computing environment in which a consent management system operates, via consent logic, to generate consent responses to consent requests based on consent data records, according to some example implementations.

FIG. 2 shows a consent data model, including a set of data objects that can be used for managing parties, including managing consent information, according to some example implementations.

FIGS. 3A-3D show a set of methods that may be implemented or otherwise used by the consent logic for managing consent, according to some example implementations.

FIG. 4 shows an example consent request, according to some example implementations.

FIG. 5 shows a consent response, according to some example implementations.

FIG. 6A is a block diagram illustrating an electronic device according to some example implementations.

FIG. 6B is a block diagram of an environment where a consent management system may be deployed, according to some implementations.

### DETAILED DESCRIPTION

The following description describes methods and apparatus for aggregating consent information in relation to records of different data objects. In particular, in some implementations, records are generated based on various data objects. Each of these data objects and corresponding records include disparate types of consent information. For example, a first data record, which is associated with a party A, may be generated based on a first data object while second and third data records, which are also each associated with party A, may be generated based on a second data object. The first data object includes a first set of fields that describes a party's general preferences for being contacted via various modes of communication. For example, the first data object may include (1) a general email consent field that indicates whether the corresponding party consents to being contacted via unsolicited email communications and (2) a general phone consent field that indicates whether the corresponding party consents to being contacted via unsolicited telephone call communications. In contrast, the second data object may include a set of data use purpose consent fields that indicate consent (e.g., an opt-in) or denial of consent (e.g., an opt-out) to contact the party for a particular purpose.

By being generated based on the first data object, the first data record may include values for the general email consent field and the general phone consent field corresponding to party A. For example, the general email consent field of the first data record may include a value that indicates consent to contact party A via email communications and the general phone consent field may include a value that indicates denial of consent to contact party A via telephone call communications. Similarly, by being generated based on the second data object, the second and third data records may include values for the set of data use purpose consent fields corresponding to party A. For example, the set of data use purpose consent fields of the second data record may indicate denial of consent to contact party A via email regarding sports related matters. In contrast, the set of data use purpose consent fields of the third data record may indicate consent to contact party A via email regarding political related matters.

In response to receipt of a consent request (i.e., an Application Programming Interface (API) request) to perform an action in relation to party A (e.g., emailing party A), a consent request system adjudicates whether consent can be provided based on (1) the data records associated with party A that include some level of consent information (e.g., the first, second, and third data records described above) and (2) details of the consent request (e.g., requested action, data use purpose, etc.). Accordingly, the adjudicated consent response aggregates consent across data records of different types (i.e., data records generated using different data objects) with corresponding levels and/or types of consent information. This consent response may be generated to comply with applicable consent regulations (e.g., The General Data Protection Regulation (GDPR)) and may be returned to a user of the consent request system such that the user can be informed of whether current consent information for party A would support an authorization to perform the requested action. The user may thereafter act according to the consent response. Further details regarding this consent management system is described in greater detail below.

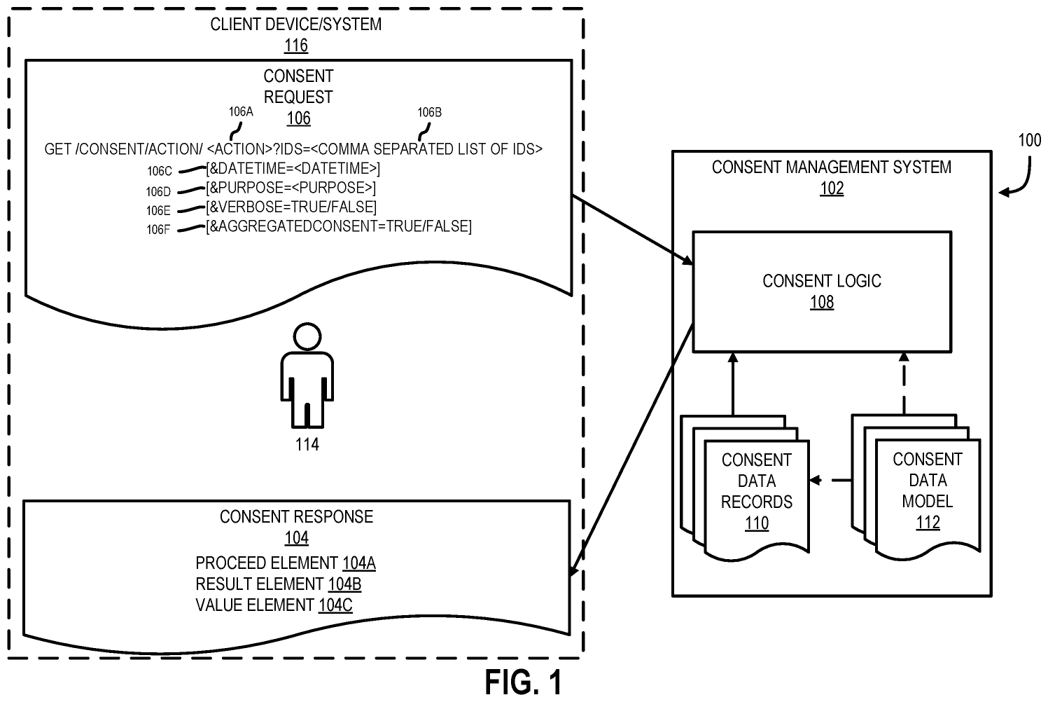

FIG. 1 shows a computing environment 100 in which a consent management system 102 operates, via consent logic 108, to generate consent responses 104 to consent requests 106 based on consent data records 110 stored within or otherwise accessible to the consent management system 102. In particular, the consent data records 110 may be generated based on various data objects designed/provided in a consent data model 112. Each of the consent data records 110 may include various types and/or levels of consent information. The consent information includes preferences of a party (sometimes referred to as an individual) for particular actions that a user 114 of the consent management system 102 would like to perform in relation to the party. The actions referenced by consent requests 106 and consent data records 110 include operations for contacting a party and/or operations related to data of a party. For example, the actions can include emailing the party, tracking geographic data corresponding to the movement of the party (sometimes referred to as geotracking), phoning the party, faxing the party, soliciting the party, processing data associated with or owned by the party, generating a profile for the party, tracking the party (e.g., tracking web activity of the party), allowing data of the party to be storing data associated with the party in a different legal jurisdiction, and forgetting data associated with the party (i.e., permanently deleting data associated with the party). In one implementation, the consent information may include an opt-in to perform a certain action in relation to a party (i.e., consent), an opt-out to perform a certain action in relation to a party (i.e., denial of consent), and/or non-opt-out to perform a certain action in relation to a party (i.e., neither consent or denial of consent has been provided by the party but the consent element has defaulted to an opt-in or opt-out value).

As shown in FIG. 1, a user 114 of the consent management system 102 may transmit or otherwise pass a consent request 106 to the consent management system 102 via a client device/system 116. The consent request 106 can include various pieces of information related to a requested action. For example, the consent request 106 may include (1) an action 106A, (2) a set of identifiers 106B corresponding to one or more parties that the action 106A will be performed in reference to (e.g., alphanumeric identifiers and/or email addresses), (3) a date stamp and/or a time stamp 106C corresponding to when the action 106A will be or was performed, (4) a data use purpose 106D describing a purpose of the action 106A, (5) a verbose parameter 106E that indicates whether explanation information is to be provided regarding support for a resulting consent response 104, and (6) an aggregation parameter 106F that indicates whether an aggregated consent response 104 covering all parties identified (i.e., identified via the set of identifiers 106B) in the consent request 106 is to be generated.

A consent response 104, which is generated in response to a consent request 106, indicates whether the action 106A indicated in the consent request 106 is determined to be authorized based on consent data records 110. As noted above, consent responses 104 may be generated based on applicable laws or regulations in corresponding jurisdictions. For example, when a requesting user 114 is located in the European Union, the consent management system 102 may generate the consent response 104 per the GDPR. In contrast, when the requesting user 114 is located within the United States, the consent management system 102 may generate the consent response 104 per federal, state, and/or locate privacy laws and regulations. In one implementation, the consent response 104 may be a multi-faceted response. For example, the consent response 104 may include three response parameters: (1) a proceed element 104A, (2) a result element 104B, and (3) a value element 104C. In this implementation, the proceed element 104A indicates whether or not consent to proceed with the requested action 106A has been determined based parameters of the consent request 106 and consent data records 110 (e.g., a value of true for the proceed parameter 104A indicates that consent has been determined or granted for the requested action 106A, while a value of false for the proceed parameter 104A indicates that consent has not been determined or granted for the requested action 106A or support has not been found to support a finding of consent for the requested action 106A). The result element 104B provides a brief indication/explanation as to why the value for the proceed element 104A was determined/returned. In particular, the values for the result element 104B can include: (1) success, which is returned if consent has been granted for all consent data records 110 contributing to the result element 104B or if at least one explicit privacy request (e.g., an explicit opt-out, request to forget, or request to stop processing) has been found in the consent data records 110; (2) infoNotFound, which is returned if none of the consent data records 110 found have consent information pertaining to the consent request 106 and corresponding consent response 104; (3) mixed, which is returned if at least one consent data record 110 does not have data pertaining to the requested action 106A or at least one consent data record 110 does have information pertaining to the requested action 106A but no explicit privacy requests (e.g., an explicit opt-out, request to forget, or request to stop processing) has been found in the consent data records 110; and (4) failure, which is returned if there has been a failure to retrieve at least one consent data record 110 and no explicit privacy requests have been found. The value element 104C provides an additional indication/explanation as to why the value for the proceed element 104A was determined/returned and can be used for determining an aggregated consent response 104. For example, the value element 104C can have the values opt-out; opt-in; opt-in, non-matching purpose; non-opt-out, seen, not seen, or unknown.

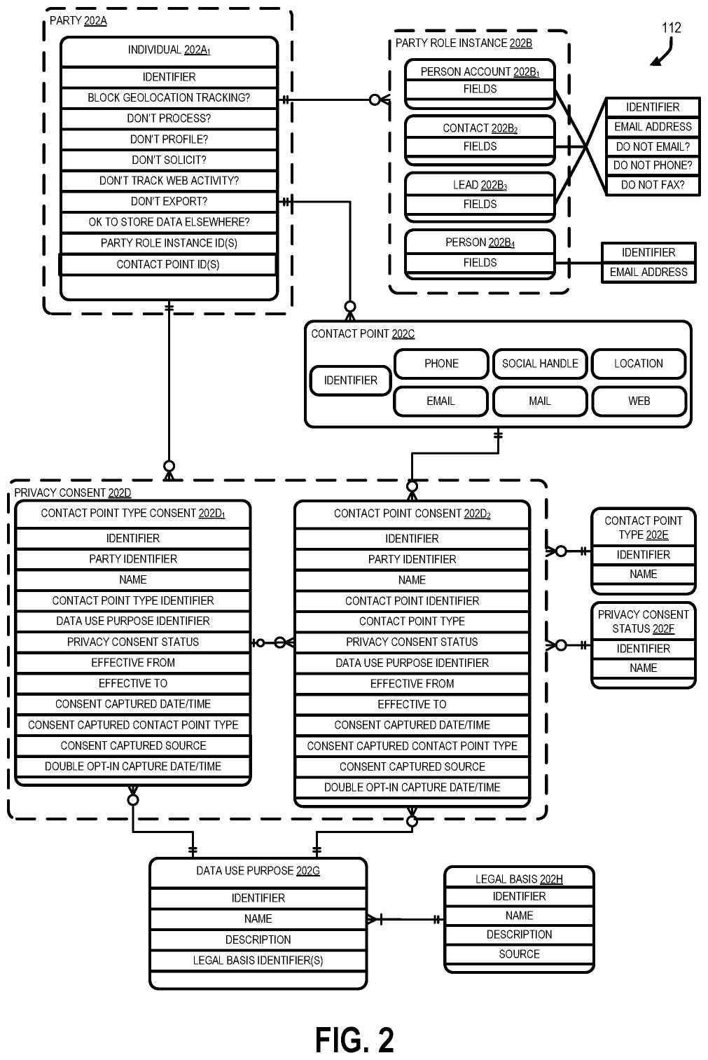

As described above, consent data records 110 may be generated based on various data objects from the consent data model 112. Each data object may include a different set of fields for representing consent information of a corresponding party. For example, FIG. 2 shows the consent data model 112 according to one example implementation.

As shown in FIG. 2, the consent data model 112 includes a set of data objects 202 that can be used for managing parties (e.g., individuals), including managing consent information, in the multi-tenant architecture of the computing environment 100. Each data object 202 will be described below by way of example. In some implementations, the consent data model 112 may include data objects in addition to the data objects 202 shown in FIG. 2 and described herein. Accordingly, the set of data objects 202 shown in FIG. 2 are for purposes of illustration and do not limit the consent data model 112.

As shown in FIG. 2, the consent data model 112 includes a set of party data objects 202A, including an individual data object 202Ai, which may be used for generating consent data records 110 associated with parties. As used herein, a consent data record 110 that is generated using the individual data object 202Ai can be referred to as an individual record 110. In one implementation, the individual data object 202Ai and corresponding individual records 110 may be used for tracking an individual's (e.g., a customer's) preferences for (1) collecting, storing, and sharing their personal data, (2) packaging their personal data so that the individual can take ownership of the personal data, (3) deleting records and personal data related to the individual, (4) solicitation directed at the individual for products and/or services, and (5) tracking the individual's geolocation and/or web activity. For example, as shown in FIG. 2, in addition to an identifier to uniquely identify corresponding individual records 110, the individual data object 202Ai may include a set of fields that describe consent information in relation to an individual's preferences. In particular, the set of fields indicate (1) whether the individual has a preference to not have their geolocation on mobile devices tracked, (2) whether the individual has a preference to not have their personal data be processed, which can include collecting, storing, and sharing personal data, (3) whether the individual has a preference to not have their personal data profiled for predicting personal attributes, such as interests, behaviors, and locations, (4) whether the individual has a preference to not be solicited regarding products and services, (5) whether the individual has a preference to not have their web activity tracked, (6) whether the individual has a preference to not have their personal data exported, and (7) whether the individual has a preference regarding storing personally identifiable information outside of their legislative/home area (e.g., whether a European Union individual authorizes personal data to be stored in devices located outside the European Union).

Each individual record 110 can be associated with consent data records 110 generated based on (1) one or more party role instance data objects 202B, (2) a contact point data object 202C, and/or (3) one or more privacy consent data objects 202D. For example, the individual data object 202Ai may also include a field that includes/references identifiers of consent data records 110 generated using a party role instance data object 202B (also referred to as party role instance records 110) and a field that includes/references identifiers of consent data records 110 generated using a contact point data object 202C (also referred to as contact point records 110).

As shown in FIG. 2, the party role instance data objects 202B can include a person account data object 202B1, a contact data object 202B2, a lead data object 202B3, and a user data object 202B4. Each of the person account data object 202Bi, contact data object 202B2, and lead data object 202B3 includes a set of fields for indicating (1) an identifier for corresponding data consent records 110, (2) an email address of a party, and (3) consent information that indicates a preference of the party regarding contacting the party via email, telephone, and fax communications (e.g., “DO NOT EMAIL?,” “DO NOT PHONE?,” and “DO NOT FAX?” fields). Accordingly, consent data records 110 generated using the person account data object 202B1, contact data object 202B2, or lead data object 202B3 (sometimes referred to as person account records 110, contact records 110, and lead records 110, respectively) directly include consent information. In contrast, a user data object 202B4 includes a set of fields for indicating (1) an identifier for corresponding consent data records 110 and (2) an email address of a party, but do not include consent information. Accordingly, consent data records 110 generated using the user data object 102B4 (sometimes referred to as user records 110) do not directly include consent information. Instead, user records 110 include consent information through association with individual records 110 (i.e., association based on inclusion of an identifier in a party role instance identifier field of an individual record 110).

As noted above, party role instance records 110 may be referenced in a party role instance identifier field of an individual record 110. When a consent request 106 is received that includes an email address that is referenced by two separate party role instance records 110 and those party role instance records 110 are referenced by different individual records 110, each set of records 110 is considered unlinked. Conversely, when two or more party role instance records 110 are referenced by a single individual record 110, these records 110 are considered linked records 110.

As noted above, in addition to party role instance data objects 202B, individual records 110 can be associated with consent data records 110 generated based on the contact point data object 202C (sometimes referred to as contact point records 110). The contact point data object 202C includes fields that contain information associated with a specific contact point type. For example, a contact point record 110 can indicate a specific phone number, email address, social handle, mail address, location, and/or web address.

As also noted above, in addition to the party role instance data objects 202B and the contact point data object 202C, individual records 110 can be associated with records 110 generated based on the privacy consent data objects 202D (sometimes referred to as privacy consent records 110). Privacy consent data objects 202D can include contact point type consent data objects 202Di and contact point consent data objects 202D2. Contact point type consent data objects 202Di include fields that describe details about how a party (e.g., an individual) has agreed to be contacted by a company or another entity. For example, a consent data record 110 generated using a contact point type consent data object 202Di (sometimes referred to as a contact point type consent record 110) can indicate that a customer/individual consented to a specific contact point (e.g., email) but not others (e.g., phone calls and mail). As shown in FIG. 2, fields of the contact point type consent data object 202Di can indicate (1) an identifier, (2) a party identifier, which identifies a corresponding party/individual (e.g., an individual record 110), (3) a name, (4) a contact point type (e.g., phone, email, etc.), (5) a data use purpose (e.g., track web browsing, profiling, marketing, billing, etc.), (6) a privacy consent status (e.g., opt-in, opt-out, not seen a request for consent (default), or has seen a request for consent but has not indicated to opt-in or opt-out), (7) an effective from date/time, (8) an effective to date/time, (9) a consent captured date/time, (10) a consent captured contact point type (e.g., phone, email, etc.), (11) a consent captured source, and (11) a double opt-in capture date/time (i.e., a secondary confirmation of consent in addition to an original selection of consent).

As shown in FIG. 2, fields of the contact point consent data object 202D2 can indicate (1) an identifier, (2) a name, (3) a party identifier, which identifies a corresponding party/individual, (4) a contact point (e.g., a specific phone, email, etc.), (5) a contact point type (e.g., phone, email, etc.), (6) a privacy consent status, (7) a data use purpose (e.g., track web browsing, profiling, marketing, billing, etc.), (8) an effective from date/time, (9) an effective to date/time, (10) a consent captured date/time, (11) a consent captured contact point type (e.g., phone, email, etc.), (12) a consent captured source, and (13) a double opt-in capture date/time. In some implementations, the privacy consent data objects 202D can be associated with one or more consent data records 110 generated based on other data objects 202 in the consent data model 112.

For example, privacy consent records 110 can be associated with consent data records 110 generated based on one or more of (1) the contact point data object 202C, (2) a contact point type data object 202E (sometimes referred to as contact point type records 110), (3) a privacy consent status data object 202F (sometimes referred to as a privacy consent status record 110), and (4) a data use purpose data object 202G (sometimes referred to as a data use purpose record 110). In this example implementation, the corresponding fields of the privacy consent data objects 202D can be identifiers to one or more of (1) contact point data records 110, (2) contact point type records 110, (3) privacy consent status records 110, and (4) data use purpose records 110 (e.g., the fields in the privacy consent data records 110 representing a contact point, a contact point type, a privacy consent status, and a data use purpose are identifiers to contact point data records 110, contact point type records 110, privacy consent status data records 110, and data use purpose records 110, respectively).

In addition to a unique identifier, the contact point type data object 202E includes a set of fields (e.g., a name field) that indicate the contact method a party has indicated a consent preference (e.g., a preference for an email, mailing address, phone number, social handle, web address, etc.). Similarly, in addition to a unique identifier, the privacy consent status data object 202F includes a set of fields (e.g., a name field) that indicate whether the customer associated with a corresponding privacy consent status record 110 agrees to this form of contact (e.g., opt-in, opt-out, not seen a request for consent (default), or has seen a request for consent but has not indicated to opt-in or opt-out).

The data use purpose data object 202G includes a set of fields, including (1) an identifier, (2) a name associated with the data use purpose, (3) a description of the data use purpose, and (4) a legal basis identifier. As shown in FIG. 2, the consent data model 112 may include a legal basis data object 202H, which represents the legal basis for contacting a customer/individual. In this implementation, in addition to a unique identifier, the legal basis data object 202H includes (1) a name of the legal basis, (2) a description of the legal basis, and (3) a source of the legal basis (e.g., consent, contractual obligation, legal obligation, public interest, etc.). The consent data records 110 generated based on the data use purpose data object 202G can reference/include one or more identifiers (via the legal basis identifier field) corresponding to consent data records 110 generated based on the legal basis data object 202H.

In some implementations, the consent data model 112 may be viewed as a four-level tiered consent model. A first level of the consent data model 112, which may be represented by individual records 110, indicates how parties/individuals want to be treated holistically (i.e., general preferences regarding tracking, data processing, etc.). A second level of the consent data model 112, which may be represented by contact point type consent records 110, indicates how a contact point/channel (e.g., email, phone, etc.) is to be treated. For example, a contact point type consent record 110 may indicate that email is the only permissible way to contact the corresponding party/individual. A third level of the consent data model 112, which may be represented by contact point consent records 110 and/or contact point records 110, indicates how a specific contact point/channel (e.g., a specific email, phone, etc.) is to be treated. For example, using a set of records 110 generated using the contact point type consent data object 202Di, the contact point consent data object 202D2, and the contact point data object 202C, a party/individual can indicate (1) at the second level of the consent data model 112, that a company may contact the party/individual using email and (2) at the third level of the consent data model 112, a first email address that the company may use to contact the party/individual and a second email address that the company may not use to contact the party/individual. A fourth level of the consent data model 112, which may be represented by the data use purpose records 110, indicates permitted and/or non-permitted data use purposes for contacting a party/individual. For example, using a set of records 110 generated using the contact point type consent data object 202Di, the contact point consent data object 202D2, the contact point data object 202C, and the data use purpose data object 202G, a party/individual can indicate (1) at the second level of the consent data model 112 that a company may contact the party/individual using email (2) at the third level of the consent data model 112 a first email address that the company may use to contact the party/individual and a second email address that the company may not use to contact the party/individual, and (3) at the fourth level of the consent data model 112 a permitted set of data use purposes (e.g., track web browsing, profiling, marketing, billing, etc.) for contacting the party/individual.

As mentioned above, the consent management system 102 includes consent logic 108 for determining a consent response 104 to a consent request 106. This consent logic 108 can aggregate consent information across consent data records 110 from potentially different types of data objects 202 to arrive at, potentially, a single consent response 104.

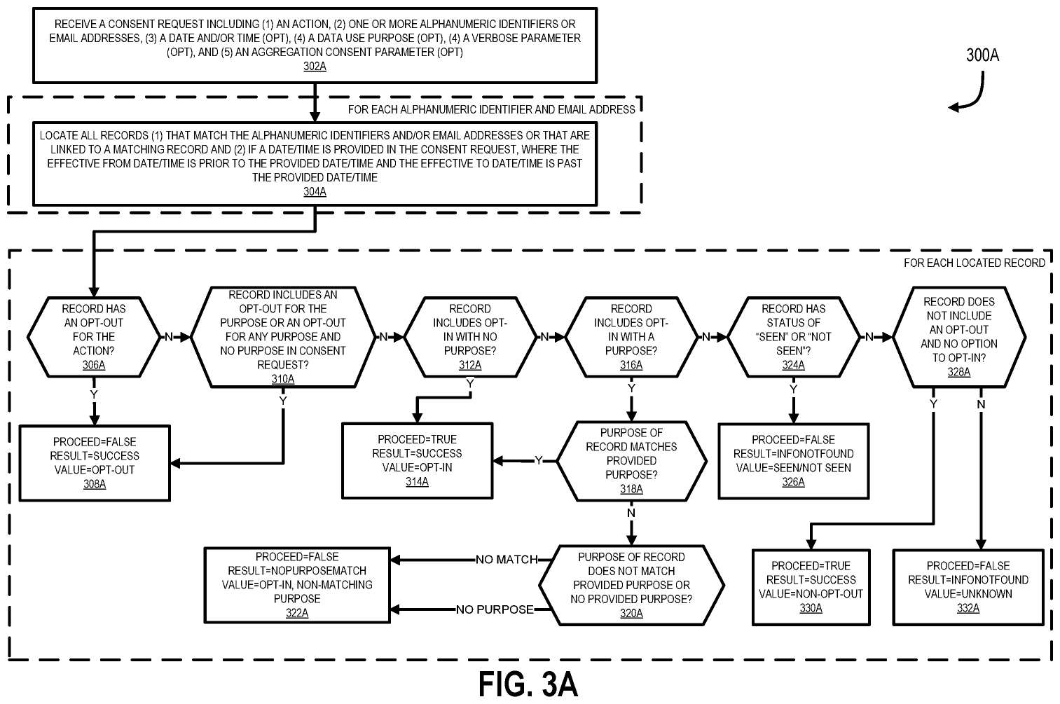

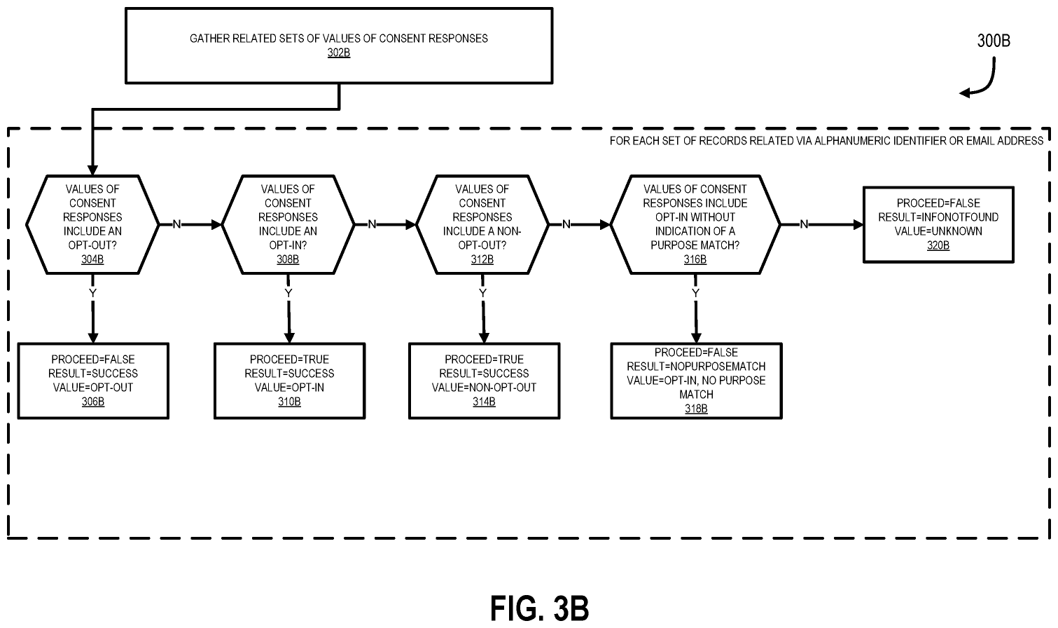

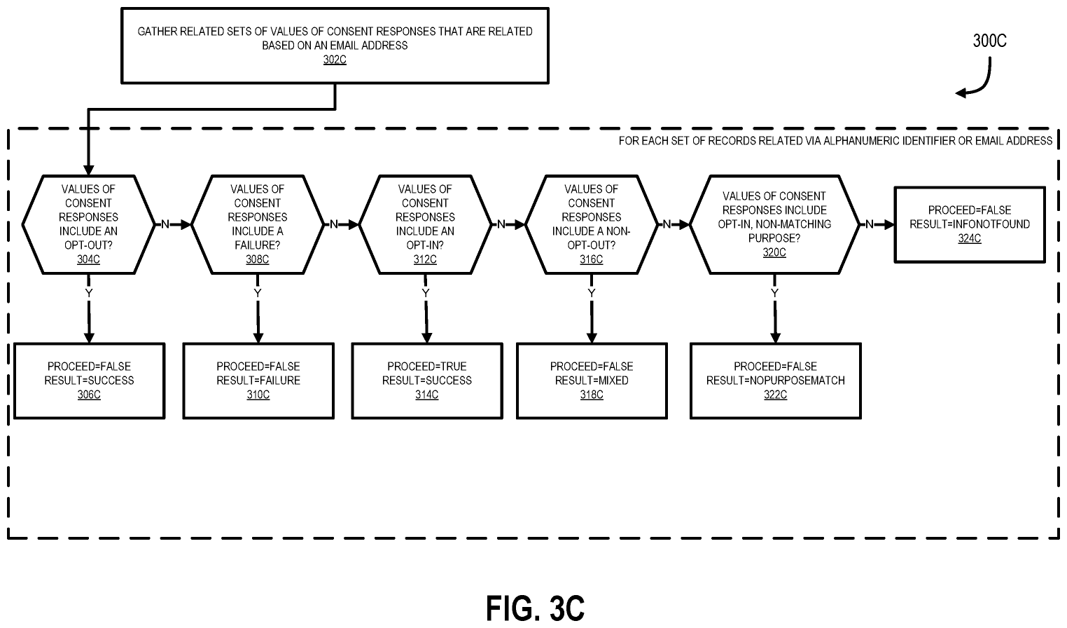

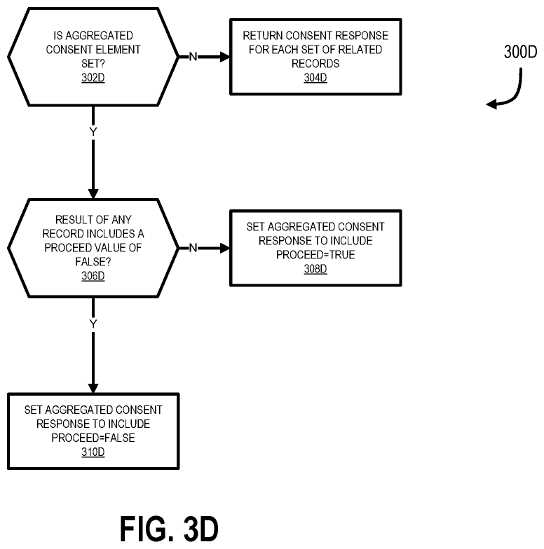

FIGS. 3A-3D show a set of methods 300A-300D, respectively, that may be implemented or otherwise used by the consent logic 108 for managing consent, according to one example implementation. The methods 300A-300D may work together such that, following performance of one method 300A-300D, one or more subsequent methods 300A-300D are performed. Although operations of the methods 300A-300D are described sequentially, in some implementations, the operations of the methods 300A-300D can be performed in partially or fully overlapping time periods. Further, in some implementations, each of the methods 300A-300D may be performed in partially or fully overlapping time periods.

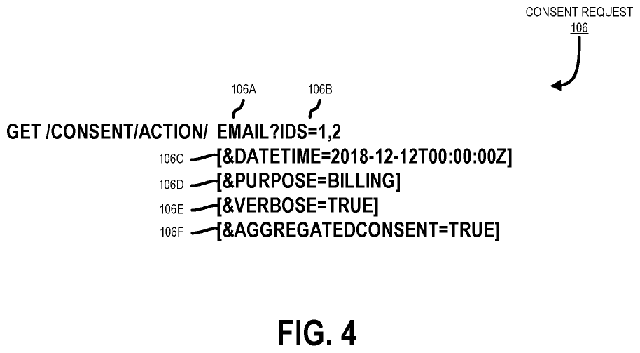

As shown in FIG. 3A, the method 300A may commence at operation 302A. At operation 302A the consent management system 102 (in particular, the consent logic 108) receives a consent request 106 from a user 114. The consent request 106 includes (1) an action 106A, (2) one or more alpha numeric identifiers or email addresses 106B (i.e., a set of identifiers), (3) a date and/or time 106C (optional), (4) a data use purpose 106D (optional), (5) a verbose parameter 106E (optional), and (6) an aggregation consent parameter 106F (optional). For example, FIG. 4 shows an example of a consent request 106 that may be received from a user 114 at operation 302A. As shown, the consent request 106 includes the action 106A of “email”, a set of alphanumeric identifiers 106B of “1,2”, a date/time 106C of “2018-12-12T00:00:00Z”, a data use purpose 106D of “billing”, a verbose parameter 106E of “true” (indicating the use of verbose consent response 104), and an aggregation consent parameter 106F of “true” (indicating an aggregated consent response 104).

At operation 304A, the consent logic 108 locates all consent records 110 that (1) match the alphanumeric identifiers and/or email addresses 106B of the consent request 106 or that are linked to a matching consent record 110 and (2) if a date/time 106C is provided in the consent request 106, have an effective from date/time prior to the provided date/time 106C of the consent request 106 and an effective to date/time past the provided date/time 106C of the consent request 106.

The subsequent operations of the method 300A are performed for each located consent record 110 from operation 304A. In particular, at operation 306A, the consent logic 108 determines, for each located consent record 110, whether the consent record 110 includes an opt-out for the action 106A of the consent request 106 (e.g., if a located consent record 110 indicates that the corresponding party has opted-out of communications via email). In response to determining that a consent record 110 includes an opt-out for the action 106A of the consent request 106, the method 300A moves to operation 308A to set the proceed element 104A of the consent response 104 for the consent record 110 to “False”, the result element 104B of the consent response 104 for the consent record 110 to “Success”, and the value element 104C of the consent response 104 for the consent record 110 to “Opt-Out”. Conversely, in response to determining that the consent record 110 does not include an opt-out for the action 106A of the consent request 106, the consent logic 108 moves to operation 310A.

At operation 310A, the consent logic 108 determines if the consent record 110 includes an opt-out for (1) the data use purpose 106D indicated in the consent request 106 or (2) for any data use purpose and the consent request 106 does not include a data use purpose 106D. In response to determining that the consent record 110 includes an opt-out for (1) the data use purpose 106D indicated in the consent request 106 or (2) for any data use purpose and the consent request 106 does not include a data use purpose 106D, the method 300A moves to operation 308A to set the proceed element 104A of the consent response 104 to “False”, the result element 104B of the consent response 104 to “Success”, and the value element 104C to “Opt-Out”. Conversely, in response to determining that the consent record 110 does not include an opt-out for (1) the data use purpose 106D indicated in the consent request 106 or (2) for any data use purpose and the consent request 106 does not include a data use purpose 106D, the method 300A moves to operation 312A.

At operation 312A, the consent logic 108 determines if the consent record 110 includes an opt-out with no indicated data use purpose. In response to determining that the consent record 110 includes an opt-out with no indicated data use purpose, the method 300A moves to operation 314A to set the proceed element 104A of the consent response 104 to “True”, the result element 104B of the consent response 104 to “Success”, and the value element 104C to “Opt-In”. Conversely, in response to determining that the consent record 110 does not include an opt-out with no indicated data use purpose, the method 300A moves to operation 316A.

At operation 316A, the consent logic 108 determines if the consent record 110 includes an opt-in with a data use purpose. In response to determining that the consent record 110 includes an opt-in with a data use purpose, the method 300A moves to operation 318A.

At operation 318A, the consent logic 108 determines if the data use purpose of the consent record 110 matches the data use purpose 106D of the consent request 106. In response to determining that the data use purpose of the consent record 110 matches the data use purpose 106D of the consent request 106, the method 300A moves to operation 314A to set the proceed element 104A of the consent response 104 to “True”, the result element 104B of the consent response 104 to “Success”, and the value element 104C to “Opt-In”. Conversely, in response to determining that the data use purpose of the consent record 110 does not match the data use purpose 106D of the consent request 106, the method 300A moves to operation 320A. At operation 320A, the consent logic 108 determines if the data use purpose of the consent record 110 does not match the data use purpose 106D of the consent request 106 or if the consent request 106 does not include a data use purpose 106D. In response to determining that the consent record 110 does not match the data use purpose 106D of the consent request 106 or that the consent request 106 does not include a data use purpose 106D, the method 300A moves to operation 322A to set the proceed element 104A of the consent response 104 to “False”, the result element 104B of the consent response 104 to “NoPurposeMatch”, and the value element 104C to “Opt-In, Non-Matching Purpose.”

Returning to operation 316A, in response to determining that the consent record 110 does not include an opt-in with a data use purpose, the method 300A moves to operation 324A. At operation 324A, the consent logic 108 determines if the consent record 110 has a status of “seen” or “not seen.” In response to determining that the consent record 110 has a status of “seen” or “not seen,” the method 300A moves to operation 326A to set the proceed element 104A of the consent response 104 to “False”, the result element 104B of the consent response 104 to “InfoNotFound”, and the value element 104C to “Seen” or “Not Seen” as is appropriate. Conversely, in response to determining that the consent record 110 does not have has a status of “seen” or “not seen,” the method 300A moves to operation 328A.

At operation 328A, the consent logic 108 determines if the consent record 110 does not include an opt-out and does not include an option to opt-in (i.e., the consent record 110 does not have a field that would allow the selection of an opt-in). In response to determining that the consent record 110 does not include an opt-out and does not include an option to opt-in, the method 300A moves to operation 330A to set the proceed element 104A of the consent response 104 to “True”, the result element 104B of the consent response 104 to “Success”, and the value element 104C to “Non-Opt-Out.” Conversely, in response to determining that the consent record 110 does include an opt-out or does include an option to opt-in, the method 300A moves to operation 332A to set the proceed element 104A of the consent response 104 to “False”, the result element 104B of the consent response 104 to “InfoNotFound”, and the value element 104C to “Unknown.”

Turning to FIG. 3B, the method 300B will be described. The method 300B may be performed based on inputs from the method 300A. For example, the method 300B may operate based on a first level/set of consent responses 104 received from the method 300A to generate a second level/set of consent responses that are relative to the sets of related consent records 110 rather than a single consent record 110.

As shown in FIG. 3B, the method 300B may commence at operation 302B with the consent logic 108 gathering/grouping sets of values 104C from consent responses 104 based on relationships/linkages between the consent records 110 (e.g., a consent record 110 is referenced or is otherwise linked to another consent record 110). For example, a relationship/linkage may be determined based on an alphanumeric identifier or an email address of a first consent record 110 referenced/included in a second consent record 110. Subsequent operations of the method 300B are performed for groups/sets of related consent records 110 and the corresponding value elements 104C of their corresponding consent responses 104, which may be determined by the method 300A.

At operation 304B, the consent logic determines if the value element 104C for any consent response 104 in a related set of consent records 110 includes an opt-out. In response to determining that the value element 104C for a consent response 104 of a consent record 110 in the related set of consent records 110 includes an opt-out, the method 300B moves to operation 306B to set the proceed element 104A of a consent response 104 for the set of related consent records 110 to “False”, the result element 104B of the consent response 104 to “Success”, and the value element 104C to “Opt-Out.” Conversely, in response to determining that no value element 104C for a consent response 104 of a consent record 110 in the related set of consent records 110 includes an opt-out, the method 300B moves to operation 308B.

At operation 308B, the consent logic determines if the value element 104C for any consent response 104 of a consent record 110 in the related set of consent records 110 includes an opt-in. In response to determining that the value element 104C for a consent response 104 of a consent record 110 in the related set of consent records 110 includes an opt-in, the method 300B moves to operation 310B to set the proceed element 104A of a consent response 104 for the set of consent records 110 to “True”, the result element 104B of the consent response 104 to “Success”, and the value element 104C to “Opt-In.” Conversely, in response to determining that no value element 104C for any consent response 104 of a consent record 110 in the set a related set of consent records 110 includes an opt-in, the method 300B moves to operation 312B.

At operation 312B, the consent logic determines if the value element 104C for any consent response 104 of a consent record 110 in the related set of consent records 110 includes a non-opt-out. In response to determining that the value element 104C for a consent response 104 of a consent record 110 in the related set of consent records 110 includes a non-opt-out, the method 300B moves to operation 314B to set the proceed element 104A of a consent response 104 for the set of consent records 110 to “True”, the result element 104B of the consent response 104 to “Success”, and the value element 104C to “Non-Opt-Out.” Conversely, in response to determining that no value element 104C for any consent response 104 of a consent record 110 in the set a related set of consent records 110 includes a non-opt-out, the method 300B moves to operation 316B.

At operation 316B, the consent logic determines if the value element 104C for any consent response 104 of a consent record 110 in the related set of consent records 110 includes an opt-in without an indication of a data purpose match (e.g., non-matching purpose). In response to determining that the value element 104C for a consent response 104 of a consent record 110 in the related set of consent records 110 includes an opt-in without an indication of a data purpose match, the method 300B moves to operation 318B to set the proceed element 104A of a consent response 104 for the set of consent records 110 to “True”, the result element 104B of the consent response 104 to “NoPurposeMatch”, and the value element 104C to “Opt-In, No Purpose Match.” Conversely, in response to determining that no value element 104C for any consent response 104 of a consent record 110 in the set a related set of consent records 110 includes an opt-in without an indication of a data purpose match, the method 300B moves to operation 320B to set the proceed element 104A of a consent response 104 for the set of consent records 110 to “False”, the result element 104B of the consent response 104 to “InfoNotFound”, and the value element 104C to “Unknown.”

Turning to FIG. 3C, the method 300C will be described. The method 300C may be performed based on inputs from the methods 300A and/or 300B. For example, the method 300C may operate based on a second level/set of consent responses 104 received from the method 300B to generate a third level/set of consent responses that are relative to the sets of related consent records 110 rather than a single consent record 110.

As shown in FIG. 3C, the method 300C may commence at operation 302C with the consent logic 108 gathering/grouping sets of values 104C from consent responses 104 based on relationships/linkages between the consent records 110 related by an email address. In one implementation, the sets of values 104C from consent responses 104 may be the consent responses 104 produced by the method 300B. Subsequent operations of the method 300B are performed for groups/sets of related consent records 110 and the corresponding value elements 104C of their corresponding consent responses 104, which were determined by the method 300A.

At operation 304C, the consent logic determines if the value element 104C for any consent response 104 of a related set of consent records 110 includes an opt-out. In response to determining that the value element 104C for a consent response 104 of a consent record 110 in the related set of consent records 110 includes an opt-out, the method 300C moves to operation 306C to set the proceed element 104A of a consent response 104 for the set of related consent records 110 to “False” and the result element 104B of the consent response 104 to “Success.” Conversely, in response to determining that no value element 104C for a consent response 104 of a consent record 110 in the related set of consent records 110 includes an opt-out, the method 300C moves to operation 308C.

At operation 308C, the consent logic determines if the value element 104C for any consent response 104 of the related set of consent records 110 includes a failure. In response to determining that the value element 104C for a consent response 104 of a consent record 110 in the related set of consent records 110 includes a failure, the method 300C moves to operation 310C to set the proceed element 104A of a consent response 104 for the set of related consent records 110 to “False” and the result element 104B of the consent response 104 to “Failure.” Conversely, in response to determining that no value element 104C for a consent response 104 of a consent record 110 in the related set of consent records 110 includes a failure, the method 300C moves to operation 312C.

At operation 312C, the consent logic determines if the value element 104C for any consent response 104 of the related set of consent records 110 includes an opt-in. In response to determining that the value element 104C for a consent response 104 of a consent record 110 in the related set of consent records 110 includes opt-in, the method 300C moves to operation 314C to set the proceed element 104A of a consent response 104 for the set of related consent records 110 to “True” and the result element 104B of the consent response 104 to “Success.” Conversely, in response to determining that no value element 104C for a consent response 104 of a consent record 110 in the related set of consent records 110 includes an opt-in, the method 300C moves to operation 316C.

At operation 316C, the consent logic determines if the value element 104C for any consent response 104 of the related set of consent records 110 includes a non-opt-out. In response to determining that the value element 104C for a consent response 104 of a consent record 110 in the related set of consent records 110 includes a non-opt-out, the method 300C moves to operation 318C to set the proceed element 104A of a consent response 104 for the set of related consent records 110 to “False” and the result element 104B of the consent response 104 to “Mixed.” Conversely, in response to determining that no value element 104C for a consent response 104 of a consent record 110 in the related set of consent records 110 includes a non-opt-out, the method 300C moves to operation 320C.

At operation 320C, the consent logic determines if the value element 104C for any consent response 104 of the related set of consent records 110 includes an opt-in, non-matching purpose. In response to determining that the value element 104C for a consent response 104 of a consent record 110 in the related set of consent records 110 includes an opt-in, non-matching purpose, the method 300C moves to operation 322C to set the proceed element 104A of a consent response 104 for the set of related consent records 110 to “False” and the result element 104B of the consent response 104 to “NoPurposeMatch.” Conversely, in response to determining that no value element 104C for a consent response 104 of a consent record 110 in the related set of consent records 110 includes an opt-in, non-matching purpose, the method 300C moves to operation 320C to set the proceed element 104A of a consent response 104 for the set of related consent records 110 to “False” and the result element 104B of the consent response 104 to “InfoNotFound.”

Turning to FIG. 3D, the method 300D will be described. The method 300D may be performed based on inputs from the other methods 300A-300C. For example, the method 300D may operate based on a third level/set of consent responses 104 received from the method 300C to generate a fourth level/set of consent responses 104 (e.g., an aggregated consent response 104) that are relative to the sets of related consent records 110 rather than a single consent record 110.

As shown in FIG. 3D, the method 300D may commence at operation 302D with the consent logic 108 determining if an aggregated consent parameter 106F is set and/or present in the consent request 106. In response to determining that the aggregated consent parameter 106F is not set and/or present in the consent request 106, the method 300D moves to operation 304D to return the previously generated consent response 104 for each set of related consent records 110 (e.g., the consent responses 104 generated by the methods 300A-300C). Conversely, in response to determining that the aggregated consent parameter 106F is set and/or present in the consent request 106, the method 300D moves to operation 306D.

At operation 306D, the consent logic 108 determines if the result element 104B of any consent response 104 includes a value of false. In response to determining that the result element 104B of all consent responses 104 do not include a value of false, the method 300D moves to operation 308D to set an aggregated consent response 104 (for all consent records 110 originally located at operation 304A) to have a proceed element 104A with a value of true.

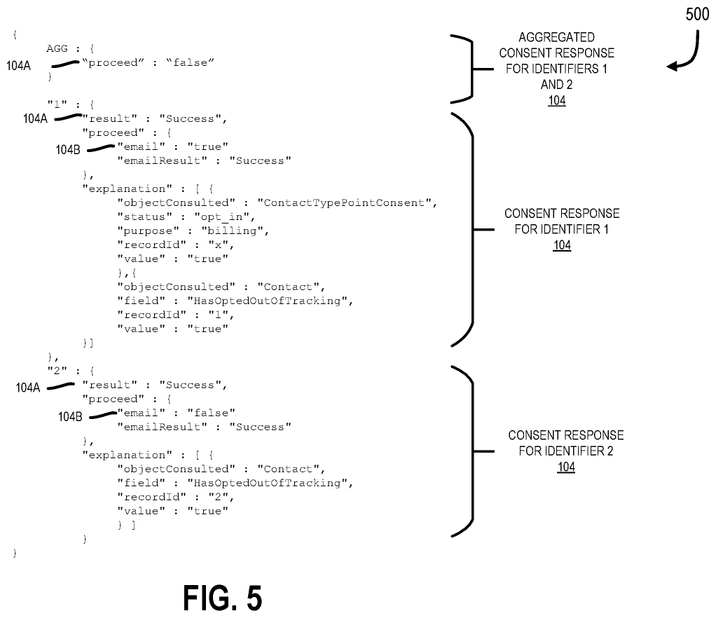

Conversely, in response to determining that the result element 104B of any consent response 104 includes a value of false, the method 300D moves to operation 310D to set an aggregated consent response 104 (for all consent records 110 originally located at operation 304A) to have a proceed element 104A with a value of false. For example, FIG. 5 shows a complete/final response 500 to the consent request 106 from FIG. 4. As shown, the response 500 includes a consent response 104 for the identifier “1”, a consent response 104 for the identifier “2”, and an aggregated consent response 104 for both the identifiers “1” and “2”. Accordingly, the user 114 is provided with different levels of granularity for responding to the consent request 106. By including multiple consent responses, the complete/final response 500 may be considered a consent response 104.

The term “user” is a generic term referring to an entity (e.g., an individual person) using a system and/or service. A multi-tenant architecture provides each tenant with a dedicated share of a software instance and the ability (typically) to input tenant specific data for user management, tenant-specific functionality, configuration, customizations, non-functional properties, associated applications, etc. Multi-tenancy contrasts with multi-instance architectures, where separate software instances operate on behalf of different tenants. A tenant includes a group of users who share a common access with specific privileges to a software instance providing a service. A tenant may be an organization (e.g., a company, department within a company, etc.). A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers. A user may have one or more roles relative to a system and/or service. To provide some examples, a user may be a representative (sometimes referred to as an “end user”) of a tenant (e.g., a vendor or customer), a representative (e.g., an administrator) of the company providing the system and/or service, and/or a representative (e.g., a programmer) of a third-party application developer that is creating and maintaining an application(s) on a Platform as a Service (PAAS).

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals- such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

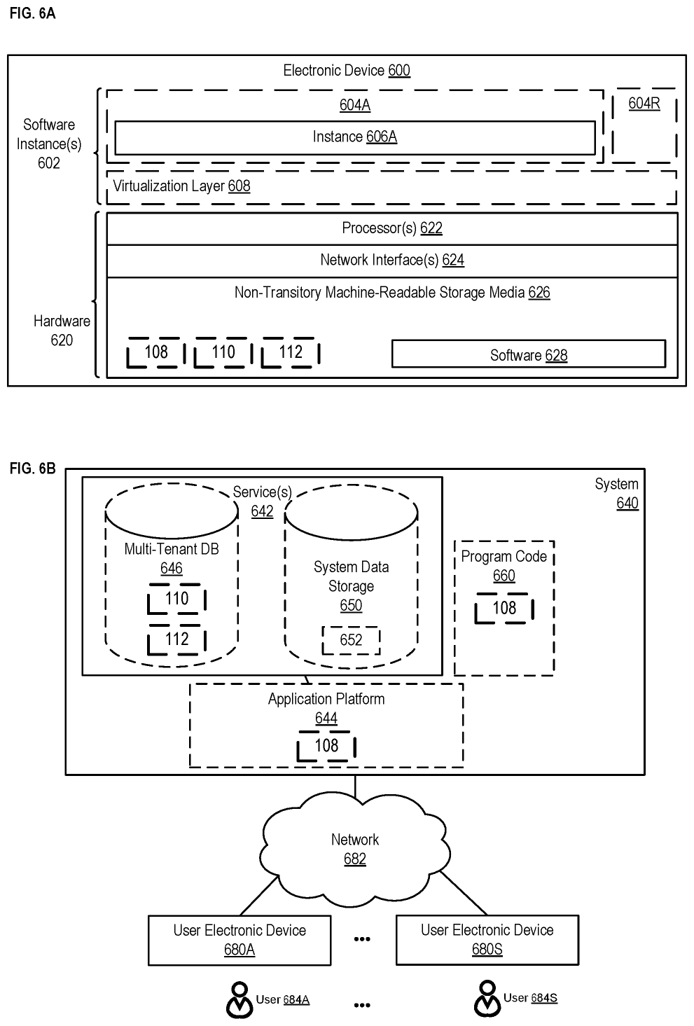

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and non-transitory machine-readable storage media 626 having stored therein software 628 (which includes instructions executable by the set of one or more processor(s) 622). Each of the previously described client device/systems 116 and the consent logic 108 may be implemented in one or more electronic devices 600. In one implementation: 1) each of the client device/systems 116 is implemented in a separate one of the electronic devices 600 (e.g., in user electronic devices operated by users where the software 628 represents the software to implement client device/systems 116 to interface with the consent logic 108 (e.g., a web browser, a native client, a portal, a command-line interface, and/or an application program interface (API) based upon protocols such as Simple Object Access Protocol (SOAP), Representational State Transfer (REST), etc.)); 2) the consent logic 108 is implemented in a separate set of one or more of the electronic devices 600 (e.g., a set of one or more server electronic devices where the software 628 represents the software to implement the consent logic 108); and 3) in operation, the electronic devices implementing the client device/systems 116 and the consent logic 108 would be communicatively coupled (e.g., by a network) and would establish between them (or through one or more other layers) connections for submitting consent requests 106 to the consent logic 108 and returning consent responses 104 to the client device/systems 116. Other configurations of electronic devices may be used in other implementations (e.g., an implementation in which the client device/system 116 and the consent logic 108 are implemented on a single electronic device 600).

In electronic devices that use compute virtualization, the set of one or more processor(s) 622 typically execute software to instantiate a virtualization layer 608 and software container(s) 604A-R (e.g., with operating system-level virtualization, the virtualization layer 608 represents the kernel of an operating system (or a shim executing on a base operating system) that allows for the creation of multiple software containers 604A-R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 628 (illustrated as instance 606A) is executed within the software container 604A on the virtualization layer 608. In electronic devices where compute virtualization is not used, the instance 606A on top of a host operating system is executed on the “bare metal” electronic device 600. The instantiation of the instance 606A, as well as the virtualization layer 608 and software containers 604A-R if implemented, are collectively referred to as software instance(s) 602.

Alternative implementations of an electronic device may have numerous variations from that described above. For example, customized hardware and/or accelerators might also be used in an electronic device.

FIG. 6B is a block diagram of an environment where a consent management system 102 may be deployed, according to some implementations. A system 640 includes hardware (a set of one or more electronic devices) and software to provide service(s) 642, including the consent logic 108. The system 640 is coupled to user electronic devices 680A-S over a network 682. The service(s) 642 may be on-demand services that are made available to one or more of the users 684A-S working for one or more other organizations (sometimes referred to as outside users) so that those organizations do not need to necessarily be concerned with building and/or maintaining a system, but instead makes use of the service(s) 642 when needed (e.g., on the demand of the users 684A-S). The service(s) 642 may communication with each other and/or with one or more of the user electronic devices 680A-S via one or more Application Programming Interface(s) (APIs) (e.g., a Representational State Transfer (REST) API). The user electronic devices 680A-S are operated by users 684A-S.

In one implementation, the system 640 is a multi-tenant cloud computing architecture supporting multiple services, such as a customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 640 may include an application platform 644 that enables PAAS for creating, managing, and executing one or more applications developed by the provider of the application platform 644, users accessing the system 640 via one or more of user electronic devices 680A-S, or third-party application developers accessing the system 640 via one or more of user electronic devices 680A-S.

In some implementations, one or more of the service(s) 642 may utilize one or more multi-tenant databases 646 for tenant data 648, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user electronic device 680A-S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the one or more multi-tenant database 646 and/or system data storage 650.

In some implementations, the service(s) 642 are implemented using virtual applications dynamically created at run time responsive to queries from the user electronic devices 680A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the consent logic 108, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 640 and the user electronic devices 680A-S.

Each user electronic device 680A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 640. For example, the user interface device can be used to access data and applications hosted by system 640, and to perform searches on stored data, and otherwise allow a user 684 to interact with various GUI pages that may be presented to a user 684. User electronic devices 680A-S might communicate with system 640 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 680A-S might include an HTTP client, commonly referred to as a “browser,” for sending and receiving HTTP messages to and from server(s) of system 640, thus allowing users 684 of the user electronic device 680A-S to access, process and view information, pages and applications available to it from system 640 over network 682.

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method for responding to a consent request for an action based on a set of records in a consent management system, the method comprising:
receiving the consent request, including a set of identifiers and the action for obtaining consent;
locating a first record of a first data object type and a second record of a second data object type, wherein the first record corresponds to a first identifier in the set of identifiers, the second record corresponds to a second identifier of the set of identifiers, and one or more of the first record and the second record includes consent information describing consent for performing the action;
determining a final response based on the first record and the second record, wherein the final response includes at least one proceed element that indicates whether consent is determined to exist for the action of the consent request based on at least the first record or the second record; and
returning the final response as a response to the consent request.

2. The method of claim 1, wherein the consent request further includes one or more of a data use purpose, which indicates a purpose for performing the action, and a time that the action is to be performed.

3. The method of claim 2, wherein the time of the consent request is within an active time range of the first record and the second record,
wherein the first record is part of a first set of records that are associated with the first identifier, and
wherein the second record part of a second set of records that are associated with the second identifier.

4. The method of claim 3, wherein the final response includes one or more of (1) a first consent response that indicates consent to perform the action in relation to the first identifier and the first set of records, (2) a second consent response that indicates consent to perform the action in relation to the second identifier and the second set of records, and (3) an aggregated response that indicates consent to perform the action in relation to the first identifier, the second identifier, the first set of records, and the second set of records.

5. The method of claim 4, wherein determining the first consent response includes setting:
a first set of proceed elements that indicate whether consent has been determined for the action in relation to respective records in the first set of records; and
a first set of value elements that indicate reasons for setting respective proceed elements in the first set of proceed elements,
wherein the first set of proceed elements and the first set of value elements are set based on one or more of (1) indications in the first set of records of an opt-in or an opt-out of a first set of actions, (2) indications of a first set of data use purposes associated with the opt-in or the opt-out of the first set of actions, including whether a data use purpose of the first set of data use purposes matches the data use purpose of the consent request, and (3) indications of whether a request to opt-in or opt-out associated with the first set of actions was seen or not seen by a party associated with the first set of records.

6. The method of claim 5, wherein determining the second consent response includes setting:
a second proceed element, that indicates whether consent has been determined for the action in relation to the second identifier and the second record; and
a second value element that indicates a reason for setting the second proceed element,
wherein the second proceed element and the second value element are set based on one or more of (1) indications in the second record of an opt-in or an opt-out of a second set of actions, (2) indications of a second set of data use purposes associated with the opt-in or the opt-out of the second set of actions, including whether a data use purpose of the second set of data use purposes matches the data use purpose of the consent request, and (3) indications of whether a request to opt-in or opt-out associated with the second set of actions was seen or not seen by a party associated with the second record.

7. The method of claim 6, wherein determining the first consent response further includes setting a third set of proceed elements and a third set of value elements based on the first set of value elements, and
wherein determining the second consent response further includes setting a fourth set of proceed elements and a fourth set of value elements based on the second set of value elements.

8. The method of claim 7, wherein determining the aggregated response is based on the third set of proceed elements and the fourth set of proceed elements.

9. A non-transitory machine-readable storage medium that provides instructions that, if executed by a processor, will cause said processor to perform operations for responding to a consent request for an action based on a set of records in a consent management system, the operations comprising:
receiving the consent request, including a set of identifiers and the action for obtaining consent;
locating a first record of a first data object type and a second record of a second data object type, wherein the first record corresponds to a first identifier in the set of identifiers, the second record corresponds to a second identifier of the set of identifiers, and one or more of the first record and the second record includes consent information describing consent for performing the action;
determining a final response based on the first record and the second record, wherein the final response includes at least one proceed element that indicates whether consent is determined to exist for the action of the consent request based on at least the first record or the second record; and
returning the final response as a response to the consent request.

10. The non-transitory machine-readable storage medium of claim 9, wherein the consent request further includes one or more of a data use purpose, which indicates a purpose for performing the action, and a time that the action is to be performed.

11. The non-transitory machine-readable storage medium of claim 10, wherein the time of the consent request is within an active time range of the first record and the second record,
wherein the first record is part of a first set of records that are associated with the first identifier, and
wherein the second record part of a second set of records that are associated with the second identifier.

12. The non-transitory machine-readable storage medium of claim 11, wherein the final response includes one or more of (1) a first consent response that indicates consent to perform the action in relation to the first identifier and the first set of records, (2) a second consent response that indicates consent to perform the action in relation to the second identifier and the second set of records, and (3) an aggregated response that indicates consent to perform the action in relation to the first identifier, the second identifier, the first set of records, and the second set of records.

13. The non-transitory machine-readable storage medium of claim 12, wherein determining the first consent response includes setting:
a first set of proceed elements that indicate whether consent has been determined for the action in relation to respective records in the first set of records; and
a first set of value elements that indicate reasons for setting respective proceed elements in the first set of proceed elements,
wherein the first set of proceed elements and the first set of value elements are set based on one or more of (1) indications in the first set of records of an opt-in or an opt-out of a first set of actions, (2) indications of a first set of data use purposes associated with the opt-in or the opt-out of the first set of actions, including whether a data use purpose of the first set of data use purposes matches the data use purpose of the consent request, and (3) indications of whether a request to opt-in or opt-out associated with the first set of actions was seen or not seen by a party associated with the first set of records.

14. The non-transitory machine-readable storage medium of claim 13, wherein determining the second consent response includes setting:
a second proceed element, that indicates whether consent has been determined for the action in relation to the second identifier and the second record; and
a second value element that indicates a reason for setting the second proceed element,
wherein the second proceed element and the second value element are set based on one or more of (1) indications in the second record of an opt-in or an opt-out of a second set of actions, (2) indications of a second set of data use purposes associated with the opt-in or the opt-out of the second set of actions, including whether a data use purpose of the second set of data use purposes matches the data use purpose of the consent request, and (3) indications of whether a request to opt-in or opt-out associated with the second set of actions was seen or not seen by a party associated with the second record.

15. The non-transitory machine-readable storage medium of claim 14, wherein determining the first consent response further includes setting a third set of proceed elements and a third set of value elements based on the first set of value elements, and
wherein determining the second consent response further includes setting a fourth set of proceed elements and a fourth set of value elements based on the second set of value elements.

16. The non-transitory machine-readable storage medium of claim 15, wherein determining the aggregated response is based on the third set of proceed elements and the fourth set of proceed elements.

17. An article of manufacture for responding to a consent request for an action based on a set of records in a consent management system, the article of manufacture comprising:
a non-transitory machine-readable storage medium that provides instructions that, if executed by a machine or network device, will cause the machine to perform operations comprising:
receiving the consent request, including a set of identifiers and the action for obtaining consent;
locating a first record of a first data object type and a second record of a second data object type, wherein the first record corresponds to a first identifier in the set of identifiers, the second record corresponds to a second identifier of the set of identifiers, and one or more of the first record and the second record includes consent information describing consent for performing the action;
determining a final response based on the first record and the second record, wherein the final response includes at least one proceed element that indicates whether consent is determined to exist for the action of the consent request based on at least the first record or the second record; and
returning the final response as a response to the consent request.

18. The article of manufacture of claim 17, wherein the consent request further includes one or more of a data use purpose, which indicates a purpose for performing the action, and a time that the action is to be performed,
wherein the time of the consent request is within an active time range of the first record and the second record,
wherein the first record is part of a first set of records that are associated with the first identifier,
wherein the second record part of a second set of records that are associated with the second identifier, and
wherein the final response includes one or more of (1) a first consent response that indicates consent to perform the action in relation to the first identifier and the first set of records, (2) a second consent response that indicates consent to perform the action in relation to the second identifier and the second set of records, and (3) an aggregated response that indicates consent to perform the action in relation to the first identifier, the second identifier, the first set of records, and the second set of records.

19. The article of manufacture of claim 18, wherein determining the first consent response includes setting:
a first set of proceed elements that indicate whether consent has been determined for the action in relation to respective records in the first set of records; and
a first set of value elements that indicate reasons for setting respective proceed elements in the first set of proceed elements,
wherein the first set of proceed elements and the first set of value elements are set based on one or more of (1) indications in the first set of records of an opt-in or an opt-out of a first set of actions, (2) indications of a first set of data use purposes associated with the opt-in or the opt-out of the first set of actions, including whether a data use purpose of the first set of data use purposes matches the data use purpose of the consent request, and (3) indications of whether a request to opt-in or opt-out associated with the first set of actions was seen or not seen by a party associated with the first set of records,
wherein determining the second consent response includes setting:
a second proceed element, that indicates whether consent has been determined for the action in relation to the second identifier and the second record; and
a second value element that indicates a reason for setting the second proceed element,
wherein the second proceed element and the second value element are set based on one or more of (1) indications in the second record of an opt-in or an opt-out of a second set of actions, (2) indications of a second set of data use purposes associated with the opt-in or the opt-out of the second set of actions, including whether a data use purpose of the second set of data use purposes matches the data use purpose of the consent request, and (3) indications of whether a request to opt-in or opt-out associated with the second set of actions was seen or not seen by a party associated with the second record.

20. The article of manufacture of claim 19, wherein determining the first consent response further includes setting a third set of proceed elements and a third set of value elements based on the first set of value elements,
wherein determining the second consent response further includes setting a fourth set of proceed elements and a fourth set of value elements based on the second set of value elements, and
wherein determining the aggregated response is based on the third set of proceed elements and the fourth set of proceed elements.
